(19) United States
(12) Patent Application Publication
(10) Pub. No.: US 2009/0268097 A1
(43) Pub. Date: Oct. 29, 2009

(54) SCENE CHANGE DETECTION METHOD AND RELATED APPARATUS ACCORDING TO SUMMATION RESULTS OF BLOCK MATCHING COSTS ASSOCIATED WITH AT LEAST TWO FRAMES

(76) Inventors: Siou-Shen Lin, Taipei County (TW); Chin-Chuan Liang, Taichung City (TW); Te-Hao Chang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/111,193

(22) Filed: Apr. 28, 2008

(51) Int. Cl. H04N 5/14

(52) U.S. Cl. 348/700; 348/E05.062

(57) ABSTRACT

A scene change detection method includes calculating a first summation result of a plurality of minimum block matching costs associated with a plurality of blocks within a first frame, calculating a second summation result of a plurality of minimum block matching costs associated with a plurality of blocks within a second frame, and determining whether a scene change occurs according to the first and second summation results.

### BACKGROUND

The present invention relates to a video detection scheme, and more particularly, to a scene change detection method and related apparatus.

In general, a segment of video consists of multiple different types of video sequences, such as a video sequence A, video sequence B, video sequence X etc. The scene change is normally referred as the situation of the video image content switches from the video sequence A to the video sequence B. Some applications, such as video coding and frame rate conversion, need to detect the occurring of the scene change and apply the operations to reduce and prevent the degrading of the video quality. For video encoding, it is necessary to detect a point of time while a scene change occurs so that the timing for inserting an I-frame (information frame) into a sequence of frames is able to be determined. For frame rate conversion, it is necessary to detect a point of time while a scene change occurs and the interpolated frame(s) is/are generated according to the detected time of a scene change.

The conventional scene change detection scheme calculates a difference between average values of luminance of a current frame and a previous/following frame. If the difference is larger than a predetermined threshold value, there is a high possibility that a scene change occurs between the current frame and the previous/following frame. The conventional scene change detection scheme, however, may not detect a scene change properly if a difference between the average values generated from the luminance of two different video sequences is very small.

Another conventional scene change detection scheme calculates a difference between two groups of reference motion vectors that are respectively associated with a previous frame and a following frame in the video. For example, if the reference motion vectors associated with the previous frame all refer to image blocks in the left direction but those vectors associated with the following frames all refer to image blocks in the right direction (i.e. the vectors are discordant), then the above-mentioned difference is larger and this may indicate that a scene change occurs. The above-mentioned difference is compared with a predetermined threshold, the conventional scene change detection scheme can detect whether a scene change occurs and encoding the video according to the detection result. Although the conventional scene change detection scheme operates correctly when applied to video encoding, it may not operate correctly when applied to a video player having A-B repeat function. This is because the video player may play a segment of video twice by using the A-B repeat function. If reference motion vectors associated with frames in the segment of video refer to image blocks in a special direction, then it is not a easy task to detect at which time a first display of the segment of video is finished and a second display of the segment of video is started (i.e., a scene change occurs) even though the conventional scene change detection scheme is used.

For example, a segment of video includes image content, which may indicate that one person rides a bicycle from the left of a background picture to the right of the background picture. When the segment of video is displayed twice by the video player having A-B repeat function, reference motion vectors associated with frames in the first and second displays of this segment of video may be almost identical, and average values of luminance of a current frame and a previous/following frame in the first and second displays may be similar. In this situation, the conventional scene change detection scheme cannot detect that a scene change occurs. Thus, it is important to provide a novel scene change detection method to solve the above-mentioned problem.

### SUMMARY

Therefore, one of the objectives of the present invention is to provide a scene change detection method and related apparatus according to summation results of minimum block matching costs corresponding to different frames, to solve the above-mentioned problems.

According to an embodiment of the present invention, a scene change detection method is disclosed. The scene change detection method comprises the following steps: calculating a first summation result of a plurality of minimum block matching costs associated with a plurality of blocks within a first frame; calculating a second summation result of a plurality of minimum block matching costs associated with a plurality of blocks within a second frame; and determining whether a scene change occurs according to the first and second summation results.

According to the embodiment of the present invention, a scene change detection apparatus is disclosed. The scene change detection apparatus comprises a calculating circuit and a decision circuit. The calculating circuit is utilized for calculating a first summation result of a plurality of minimum block matching costs associated with a plurality of blocks within a first frame and for calculating a second summation result of a plurality of minimum block matching costs associated with a plurality of blocks within a second frame. The decision circuit is coupled to the calculating circuit and utilized for determining whether a scene change occurs according to the first and second summation results.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a scene change detection apparatus according to a first embodiment of the present invention.

FIG. 2 is a block diagram of a scene change detection apparatus according to a second embodiment of the present invention.

FIG. 3 is a flowchart illustrating operation of the scene change detection apparatus shown in FIG. 1.

FIG. 4 is a flowchart illustrating operation of the scene change detection apparatus shown in FIG. 2.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

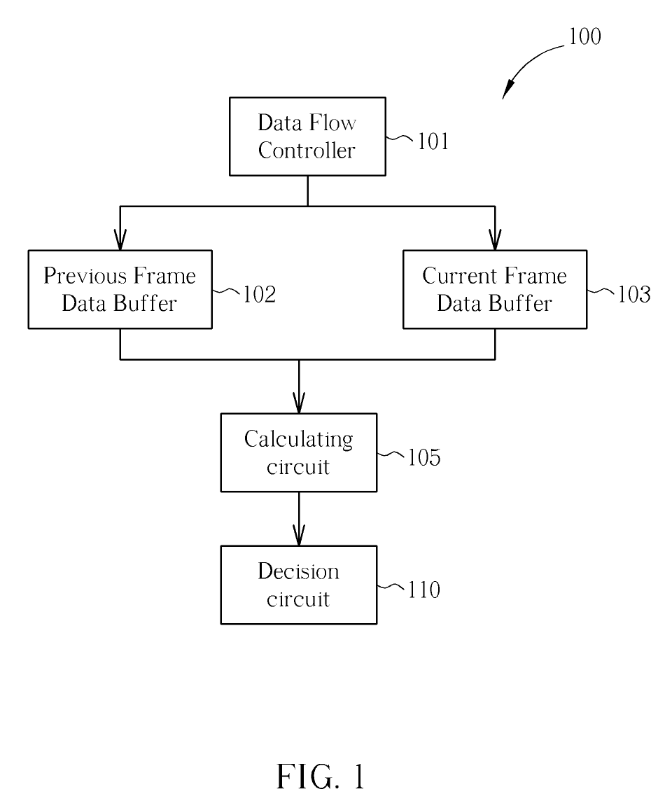

Please refer to FIG. 1. FIG. 1 is a block diagram of a scene change detection apparatus 100 according to a first embodiment of the present invention. As shown in FIG. 1, the scene change detection apparatus 100 comprises a data flow controller 101, a previous frame data buffer 102, a current frame data buffer 103, a calculating circuit 105, and a decision circuit 110. The data flow controller 101 is utilized for controlling the previous and current frame data buffers 102 and 103 to respectively output previous frame data and current frame data to the calculating circuit 105. The calculating circuit 105 is utilized for calculating a first summation result R₁ of a plurality of minimum block matching costs associated with a plurality of image blocks within a first frame, and also for calculating a second summation result R₂ of a plurality of minimum block matching costs associated with a plurality of image blocks within a second frame. For example, the second frame follows the first frame; i.e. in this example, the first frame is meant to be a previous frame, and the second frame is meant to be a current frame. The decision circuit 110 is used for determining whether a scene change occurs according to the first and second summation results R₁ and R₂, which are generated by the calculating circuit 105.

Specifically, the decision circuit 110 determines that a scene change occurs when a difference D₁ between the first and second summation results R₁ and R₂ is greater than a predetermined threshold value Vₜₕ. Therefore, the scene change detection apparatus 100 is able to determine whether a scene change occurs between the first and second frames (i.e., the previous and current frames) or not by computing the difference D₁ between the respective summation results R₁ and R₂. The reason is that a burst increment/decrement in a summation result of minimum block matching costs arising between the previous and current frames often represents that target motion vectors used for decoding the previous frame are different and conflicting from those used for decoding the current frame. In other words, the scene change detection apparatus 100 is able to determine whether a scene change occurs between the continuous frames or not by computing a difference between respective summation results of minimum block matching costs corresponding to two continuous frames. When the scene change detection apparatus 100 is applied to a video player having A-B repeat function, there is also a great possibility that the scene change detection apparatus 100 is able to correctly detect the scene change by comparing the above-mentioned difference D₁ with the predetermined threshold value Vₜₕ whether the above-mentioned target motion vectors are conflicting or not.

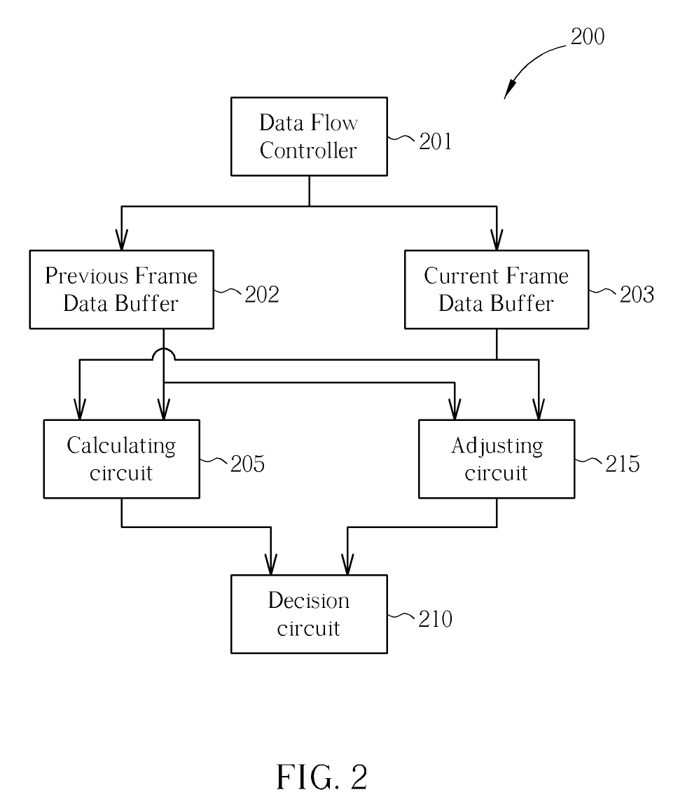

Please refer to FIG. 2. FIG. 2 is a block diagram of a scene change detection apparatus 200 according to a second embodiment of the present invention. The scene change detection apparatus 200 comprises a data flow controller 201, a previous frame data buffer 202, a current frame data buffer 203, a calculating circuit 205, an adjusting circuit 215, and a decision circuit 210. Functions and operations of the data flow controller 201, previous and current frame data buffers 202 and 203, and the calculating circuit 205 are identical to those of the data flow controller 101, previous and current frame data buffers 102 and 103, and the calculating circuit 105; further description is not detailed for simplicity. A major difference between this embodiment and the first embodiment is that the scene change detection apparatus 200 further utilizes the adjusting circuit 215 to generate a plurality of adjustments associated with texture information of the first and second frames. The decision circuit 210 then determines whether a scene change occurs according to a first summation result R₁′, a second summation result R₂′, and the adjustments, where the method of generating the first and second summation results R₁′ and R₂′ is also identical to that for generating the first and second summation results R₁ and R₂ shown in FIG. 1.

Specifically, the decision circuit 210 combines the above-mentioned adjustments with the first and second summation results R₁′ and R₂′ to obtain adjusted summation results R₁′_{adj} and R₂′_{adj}, respectively, and then determines whether the scene change occurs according to the adjusted summation results R₁′_{adj} and R₂′_{adj}. If a difference D₂ between the adjusted summation results R₁′_{adj} and R₂′_{adj} is greater than a predetermined threshold value Vₜₕ′, the decision circuit 210 decides that a scene change occurs between the previous and current frames. The reason why the scene change detection apparatus 200 refers to the adjusted summation results R₁′_{adj} and R₂′_{adj} to decide whether the scene change occurs is described in the following. For the first embodiment, when the previous and current frames have complex texture information, an order of difference D₁ between the summation results R₁ and R₂ of the minimum block matching costs corresponding to the previous and current frames is usually considerably larger than that of a difference D₁′ between summation results of minimum block matching costs corresponding to two continuous frames having plain texture information. It is possible that the value of the difference D₁ is larger than the predetermined threshold value Vₜₕ and therefore the scene change detection apparatus 100 decides that a scene change occurs. But actually no scene change occurs between the previous and current frames. This is because the order of the difference D₁ is very large so the value of the difference D₁ is usually greater than the predetermined threshold value Vₜₕ. In other words, in this situation, the scene change detection apparatus 100 may make an erroneous decision by determining that the scene change occurs. In addition, the order of the difference D₁′ is very small so that the value of the difference D₂ is usually smaller than the predetermined threshold value Vₜₕ. In this situation, the scene change detection apparatus 100 may make another erroneous decision by determining that no scene change occurs, but a scene change actually occurs. In order to enhance the function of the scene change detection apparatus 100 in the first embodiment, the scene change detection apparatus 200 is provided in the second embodiment accordingly.

In the following description, two examples are provided for generating these adjustments by considering different factors respectively. In the first example, the adjusting circuit 215 generates the adjustments according to variances of pixel values within image blocks referenced by target motion vectors corresponding to the minimum block matching costs. In particular, for each frame, the adjusting circuit 215 calculates a total summation result of variances of pixel values within multiple image blocks, which are referenced by target motion vectors corresponding to the minimum block matching costs respectively. The adjusting circuit 215 then takes this summation result as an adjustment associated with this frame. Those skilled in this art should appreciate how to generate a variance sum of pixel values within each image block; further description is not explained for brevity. Thus, the calculating circuit 215 can generate two different adjustments associated with texture information of the first and second frames (i.e., the previous and current frames) only if the first and second frames are different. Next, the decision circuit 210 receives the adjustments and then subtracts the adjustments from the first and second summation results R₁′ and R₂′ respectively, to obtain the adjusted summation results R₁′_{adj} and R₂′_{adj}. Consequently, when the difference D₂ between the adjusted summation results R₁′_{adj} and R₂′_{adj} is larger than the predetermined threshold value Vₜₕ′, the decision circuit 210 determines that a scene change occurs, as mentioned above.

In the second example, the adjusting circuit 215 generates the adjustments according to the summation results of the pixel differences associated with the respectively spatial gradients within multiple image blocks, which are referenced by target motion vectors corresponding to the minimum block matching costs respectively. For instance, the adjusting circuit 215 calculates two total pixel differences between different pixels associated with spatial gradients in the previous and current frames respectively, to generate the adjustments. With regards to an image block referenced by a target motion vector in a previous frame, the adjusting circuit 215 subtracts the value of each left-top pixel from the value of each current pixel respectively to obtain pixel differences associated with this image block itself. The adjusting circuit 215 then sums up the pixel differences corresponding to all the image blocks to generate a specific summation result as an adjustment associated with this previous frame. Next, in a similar way, the adjusting circuit 215 generates another summation result as an adjustment associated with a current frame. Therefore, the decision circuit 210 can correctly determine whether a scene change occurs between the previous and current frames by referring to adjusted summation results R₁′_{adj} and R₂′_{adj}, which are generated by subtracting the above-described adjustments from the first and second summation results R₁′ and R₂′. Of course, the adjusting circuit 215 can also obtain the pixel differences associated with the image block by subtracting the value of each right-top/right/left pixel from the value of each current pixel respectively; this also obeys the spirit of the present invention. Moreover, for the previous and current frames, the adjusting circuit 215 can generate different adjustments according to other texture information (e.g., edge information) of multiple image blocks, which are referred to by the target motion vectors associated with the previous and current frames respectively.

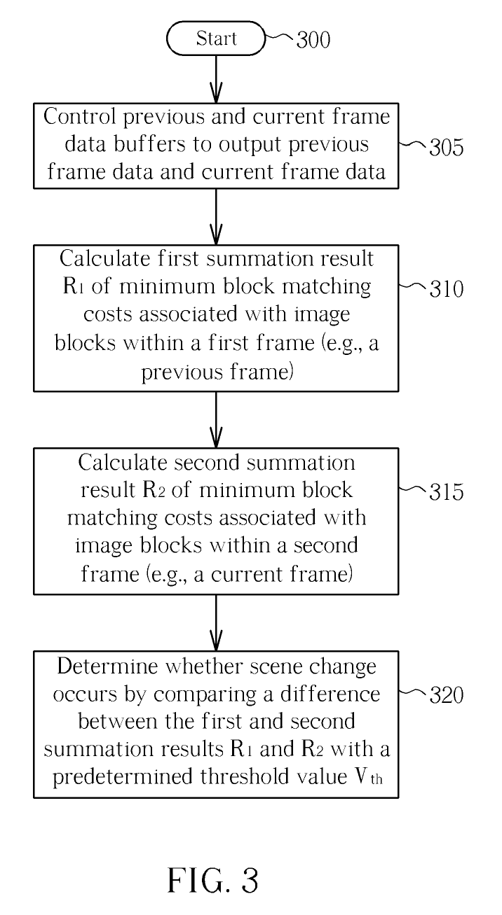

In order to explain the spirit of the present invention more clearly, related flowcharts corresponding to the first and second embodiments shown in FIG. 1 and FIG. 2 respectively are illustrated as follows. Please refer to FIG. 3. FIG. 3 is a flowchart illustrating the operation of the scene change detection apparatus 100 shown in FIG. 1. Steps of this flowchart are detailed in the following:

### Step 300: Start;

Step 305: Control the previous and current frame data buffers 102 and 103 to output previous frame data and current frame data;
Step 310: Calculate the first summation result R₁ of the minimum block matching costs associated with the image blocks within the first frame (e.g., the previous frame);
Step 315: Calculate the second summation result R₂ of the minimum block matching costs associated with the image blocks within the second frame (e.g., the current frame); and
Step 320: Determine whether a scene change occurs by comparing the difference between the first and second summation results R₁ and R₂ with the predetermined threshold value Vₜₕ.

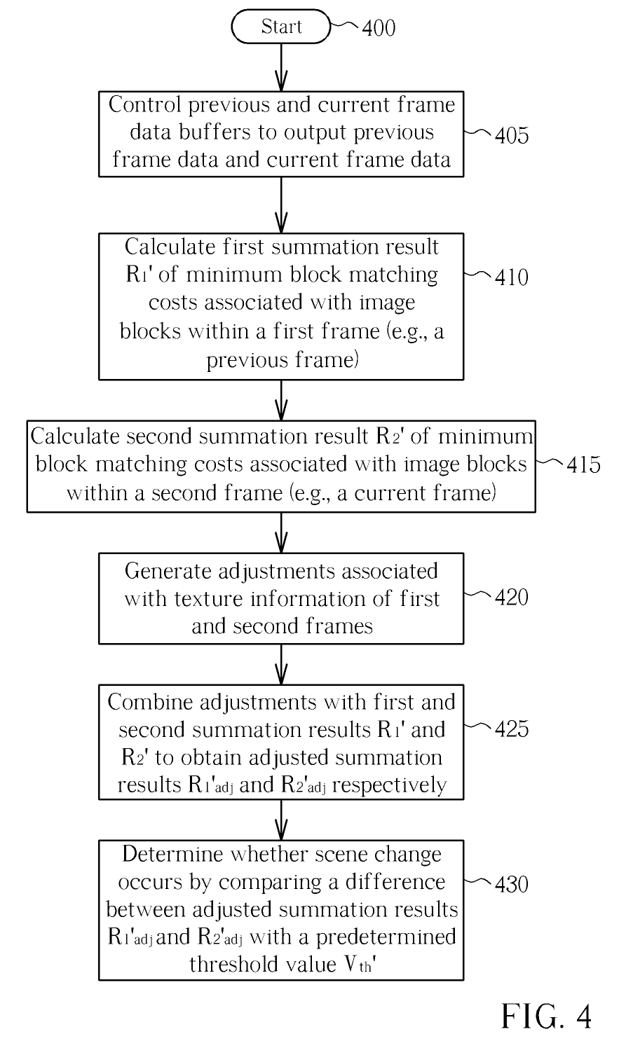

Please refer to FIG. 4. FIG. 4 is a flowchart illustrating the operation of the scene change detection apparatus 200 shown in FIG. 2. Steps of this flowchart are detailed as follows:

### Step 400: Start;

Step 405: Control the previous and current frame data buffers 202 and 203 to output previous frame data and current frame data;
Step 410: Calculate the first summation result R₁′ of the minimum block matching costs associated with the image blocks within the first frame (e.g., the previous frame);
Step 415: Calculate the second summation result R₂′ of the minimum block matching costs associated with the image blocks within the second frame (e.g., the current frame);
Step 420: Generate the adjustments associated with texture information of the first and second frames;
Step 425: Combine the adjustments with the first and second summation results R₁′ and R₂′ to obtain the adjusted summation results R₁′_{adj} and R₂′_{adj}, respectively; and
Step 430: Determine whether the scene change occurs by comparing the difference between the adjusted summation results R₁′_{adj} and R₂′_{adj} with the predetermined threshold value Vₜₕ′.

Those skilled in the art will readily observe that numerous modifications and alterations of the device and method may be made while retaining the teachings of the invention.

What is claimed is:

1. A scene change detection method, comprising:
calculating a first summation result of a plurality of minimum block matching costs associated with a plurality of blocks within a first frame;
calculating a second summation result of a plurality of minimum block matching costs associated with a plurality of blocks within a second frame; and
determining whether a scene change occurs according to the first and second summation results.

2. The scene change detection method of claim 1, wherein the step of determining whether the scene change occurs according to the first and second summation results comprises:
when a difference between the first and second summation results is greater than a predetermined threshold value, determining that the scene change occurs.

3. The scene change detection method of claim 1, further comprising:
generating a plurality of adjustments associated with texture information of the first and second frames; and
the step of determining whether the scene change occurs comprises:
determining whether the scene change occurs according to the first summation result, the second summation result, and the adjustments.

4. The scene change detection method of claim 3, wherein the step of determining whether the scene change occurs according to the first summation result, the second summation result, and the adjustments comprises:
combining the adjustments associated with the texture information of the first and second frames with the first and second summation results respectively to obtain a plurality of adjusted summation results; and
determining whether the scene change occurs according to the adjusted summation results.

5. The scene change detection method of claim 4, wherein the step of determining whether the scene change occurs according to the adjusted summation results comprises:
when a difference between the adjusted summation results is greater than a predetermined threshold value, determining that the scene change occurs.

6. The scene change detection method of claim 3, wherein the adjustments are respectively generated according to variances of pixel values within image blocks referenced by target motion vectors corresponding to the minimum block matching costs.

7. The scene change detection method of claim 3, wherein the adjustments are respectively generated according to summation results of pixel differences associated with spatial gradients within image blocks referenced by target motion vectors corresponding to the minimum block matching costs.

8. A scene change detection apparatus, comprising:
a calculating circuit, for calculating a first summation result of a plurality of minimum block matching costs associated with a plurality of blocks within a first frame and for calculating a second summation result of a plurality of minimum block matching costs associated with a plurality of blocks within a second frame; and
a decision circuit, coupled to the calculating circuit, for determining whether a scene change occurs according to the first and second summation results.

9. The scene change detection apparatus of claim 8, wherein the decision circuit determines that the scene change occurs when a difference between the first and second summation results is greater than a predetermined threshold value.

10. The scene change detection apparatus of claim 8, further comprising:
an adjusting circuit, coupled to the decision circuit, for generating a plurality of adjustments associated with texture information of the first and second frames;
wherein the decision circuit determines whether the scene change occurs according to the first summation result, the second summation result, and the adjustments.

11. The scene change detection apparatus of claim 10, wherein the decision circuit combines the adjustments associated with the texture information of the first and second frames with the first and second summation results to obtain a plurality of adjusted summation results, respectively, and determines whether the scene change occurs according to the adjusted summation results.

12. The scene change detection apparatus of claim 11, wherein the decision circuit determines that the scene change occurs when a difference between the adjusted summation results is greater than a predetermined threshold value.

13. The scene change detection apparatus of claim 10, wherein the adjusting circuit generates the adjustments according to variances of pixel values within image blocks referenced by target motion vectors corresponding to the minimum block matching costs, respectively.

14. The scene change detection apparatus of claim 10, wherein the adjusting circuit generates the adjustments according to summation results of pixel differences associated with spatial gradients within image blocks referenced by target motion vectors corresponding to the minimum block matching costs, respectively.
